(19) United States
(12) Patent Application Publication
(10) Pub. No.: US 2014/0071563 A1
(43) Pub. Date: Mar. 13, 2014

(54) MONITORING SYSTEM FOR AND METHOD OF PREVENTING ELECTRICAL ARCS IN A SOLAR ENERGY SYSTEM

(71) Applicant: Dean Solon, Gallatin, TN (US)

(72) Inventor: Dean Solon, Gallatin, TN (US)

(21) Appl. No.: 14/022,533

(22) Filed: Sep. 10, 2013

Related U.S. Application Data
(60) Provisional application No. 61/699,206, filed on Sep. 10, 2012.

(51) Int. Cl. H02H 1/00

(52) U.S. Cl. CPC H02H 1/0015
USPC 361/2

(57) ABSTRACT

A monitoring system for and method of preventing electrical arcs in a solar energy system is disclosed. The monitoring system includes an insulation resistance (IR) monitoring device, a disconnect switch, a power supply, an indicator, and optionally a communications interface. A method of preventing electrical arcs in a solar energy system using the monitoring system may include, but is not limited to, the steps of providing and installing the monitoring system in a solar energy system; activating the solar energy system and the monitoring system; continuously monitoring the insulation resistance of a conductor; if the lower and/or upper resistance threshold of the IR monitoring device is not satisfied, then transmitting a shutdown signal to the disconnect switch, thereby turning off the power to the affected circuit, and indicating the presence of the potential fault condition.

### CROSS REFERENCE TO RELATED APPLICATIONS

This application claims the benefit of U.S. Provisional Patent Application 61/699,206, which was filed Sep, 10, 2012.

### TECHNICAL FIELD

The present invention relates generally to components used in solar energy systems, and more particularly to a monitoring system for and method of preventing electrical arcs in a solar energy system.

### BACKGROUND

Large scale solar energy systems are an increasingly important source of renewable energy. Typically these solar energy systems include an array of solar collectors connected to various components related to efficiency, safety, and the like. Unfortunately, because the requisite connections are predominantly outside and exposed, they are subject to deterioration and damage arising from a variety of sources, such as ultraviolet (UV) degradation of materials, vandalism, falling debris, animals, clumsy workers, and the like.

When an electrical connector or wire ceases to operate as intended the connected components may stop working, which decreases efficiency and may damage or destroy the solar infrastructure. Another possibility, which happens when the insulation on a connector or wire is damaged or destroyed, is that an exposed live wire is grounded, which may cause an electrical arc. Consequently, damaged insulation can result in fires, burns, and other damages associated with faulty system operations. This is potentially disastrous to equipment, to the surrounding area, and to personnel. Therefore, there is a need for new approaches for preventing unexpected and unwanted arcing in solar energy systems.

### SUMMARY

A monitoring system for and method of preventing electrical arcs in a solar energy system includes an insulation resistance (IR) monitoring device, a disconnect switch, a power supply, an indicator, and optionally a communications interface. A method of preventing electrical arcs in a solar energy system using the monitoring system includes the steps of providing and installing the monitoring system in a solar energy system; activating the solar energy system and the monitoring system; continuously monitoring the insulation resistance of a conductor; if the lower and/or upper resistance threshold of the IR monitoring device is not satisfied, then transmitting a shutdown signal to the disconnect switch, thereby turning off the power to the affected circuit, and indicating the presence of the potential fault condition.

### BRIEF DESCRIPTION OF THE DRAWINGS

The features and advantages of the present invention will be more clearly understood from the following description taken in conjunction with the accompanying drawings, wherein:

FIG. 1 illustrates a block diagram of an example of a monitoring system for preventing electrical arcs in a solar energy system;

FIG. 2, FIG. 3, FIG. 4, FIG. 5, and FIG. 6 illustrate various views of an example of a monitoring system assembly for implementing the monitoring system of FIG. 1;

FIG. 7, FIG. 8, and FIG. 9 illustrate various views of the monitoring system assembly without the handle assembly and wires; and

FIG. 10 illustrates a flow diagram of an example of a method of preventing electrical arcs in a solar energy system using the monitoring system of FIG. 1.

### DETAILED DESCRIPTION OF THE PREFERRED EMBODIMENTS

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The invention provides a monitoring system for and method of preventing electrical arcs in a solar energy system. Namely, the presently disclosed monitoring system and method provide a proactive arc fault detection mechanism in a solar energy system by measuring the insulation resistance of a conductor (e.g., wire or cable) or connector in, for example, the DC photovoltaic (PV) source and/or output circuits of the solar energy system. For example, mechanisms are provided for measuring the insulation resistance of a PV wire, wherein the insulation resistance is monitored substantially continuously in order to detect deterioration prior to an electrical arcing condition (or fault condition) occurring. Accordingly, the presently disclosed monitoring system allows for the early detection of potential arc fault conditions and can be used to shut down the power in a solar energy system prior to an actual arc occurring, thereby reducing or entirely eliminating a potential hazardous condition from occurring.

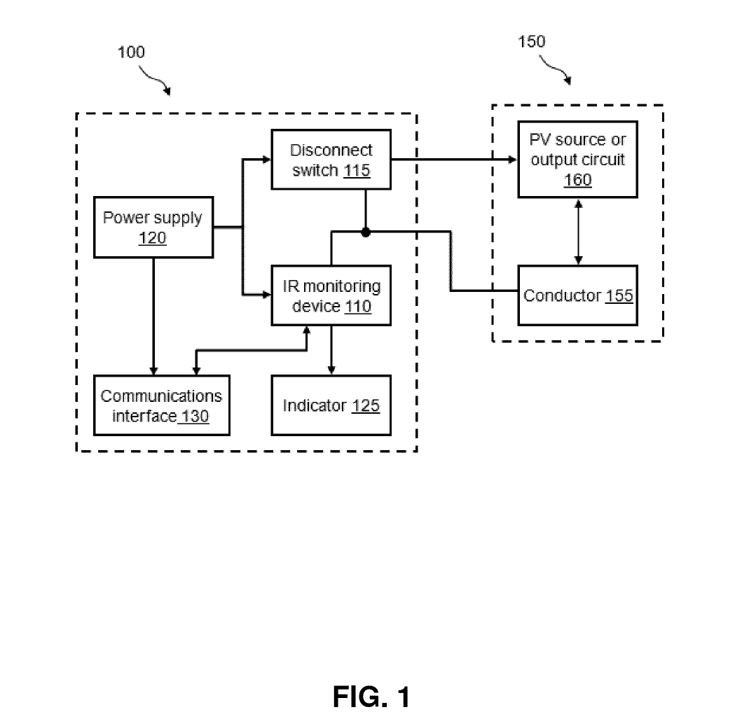

FIG. 1 illustrates a block diagram of an example of a monitoring system 100 for preventing electrical arcs in a solar energy system. The presently disclosed monitoring system 100 comprises an insulation resistance (IR) monitoring device 110 and a disconnect switch 115, both of which are powered by a power supply 120.

The monitoring system 100 is used in combination with a solar energy system for the early detection of potential arc fault conditions therein. For example, FIG. 1 shows a portion of a solar energy system 150 that includes multiple conductors 155 that are associated with, for example, a PV source or output circuit 160. In this example, the monitoring system 100 is used to monitor the insulation resistance of the multiple conductors 155 and detect the presence of a potential arc fault condition and, if necessary, shut down, in this example, the PV source or output circuit 160 before the arc fault condition occurs.

The IR monitoring device 110 is a device for monitoring the insulation resistance of a conductor or connector in a solar energy system. For example, the IR monitoring device 110 is used to monitor the insulation resistance of the conductor 155 of the solar energy system 150. The IR monitoring device 110 uses a pulsating measuring signal which is fed into the solar energy system to be monitored (e.g., solar energy system 150) and the insulation resistance of each of the conductors 155 is calculated. This pulsating measuring signal alters its form depending on the insulation resistance and system leakage capacitance. From this altered signal the change in the insulation resistance is forecast. When the forecast insulation resistance corresponds to the insulation resistance calculated in the next measurement cycle and is smaller than the set threshold value, the shutdown signal of the IR monitoring device 110 is activated. Depending on the solar energy system, the operating voltage of the IR monitoring device 110 can be, for example, from about 600 volts DC to about 1000 volts DC. In one example, the IR monitoring device 110 is the CM series of monitoring relays available from ABB Ltd.

The IR monitoring device 110 is electrically connected to an input of the disconnect switch 115. Depending on the solar energy system, the operating voltage of the disconnect switch 115 can be, for example, from about 600 volts DC to about 1000 volts DC. In one example, the disconnect switch 115 is the T4N250 switch available from ABB Ltd.

The power supply 120 is a DC power supply, wherein the specifications of the power supply 120 are dependent on the power requirements of the IR monitoring device 110 and the disconnect switch 115. The output of the power supply 120 can range, for example, from about 12 volts DC to about 24 volts DC. In one example, the power supply 120 is a 24-volt DC, 5 amp power supply, such as the CP-C24/5.0 power supply available from ABB Ltd.

In operation, the IR monitoring device 110 is used to continuously monitor the condition of the insulation of a photovoltaic wire (e.g., the conductor 155) by measuring its insulation resistance. As is well known, an IR monitoring device continuously measures the insulation resistance by injecting a pulsed measuring signal into the system and monitoring the altered signal to determine the insulation resistance change. In the monitoring system 100, the IR monitoring device 110 continuously measures the insulation resistance of, for example, the conductors 155 and releases a signal whenever one of two thresholds is exceeded. The initial threshold will send out a warning signal and the second threshold will shut down the power and send out a shutdown signal. Namely, the signal is modified based on the amount of insulation resistance and system leakage capacitance. A change in the wire insulation resistance can be an indicator of insulation failure.

Upon detecting a change (i.e., a reduction) in insulation resistance with respect to a preset threshold value, which is an indication of a potential arc fault condition, the IR monitoring device 110 trips, which subsequently trips the disconnect switch 115. By tripping the disconnect switch 115, the PV source or output circuit 160 is turned off. This proactive approach to arc fault detection allows the early detection of potential electrical problems and shuts down the power in a solar energy system prior to an actual arc and potential hazardous condition occurring. This chain of events preferably also activates an indicator 125, such as a visual signal light. The indicator 125, such as a light-emitting diode (LED), can be integrated into the IR monitoring device 110 or into the disconnect switch 115 or into both. Optionally, the monitoring system 100 comprises a communications interface 130, wherein the communications interface 130 transmits a message (text, email, or otherwise) to the designated operator of the solar energy system in the event that the IR monitoring device 110 and/or the disconnect switch 115 is tripped.

The communications interface 130 may be any wired and/or wireless communication interface for connecting to a network (not shown) and by which information may be exchanged with other devices (not shown) connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Wi-Fi, Wi-Max, IEEE 802.11 technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

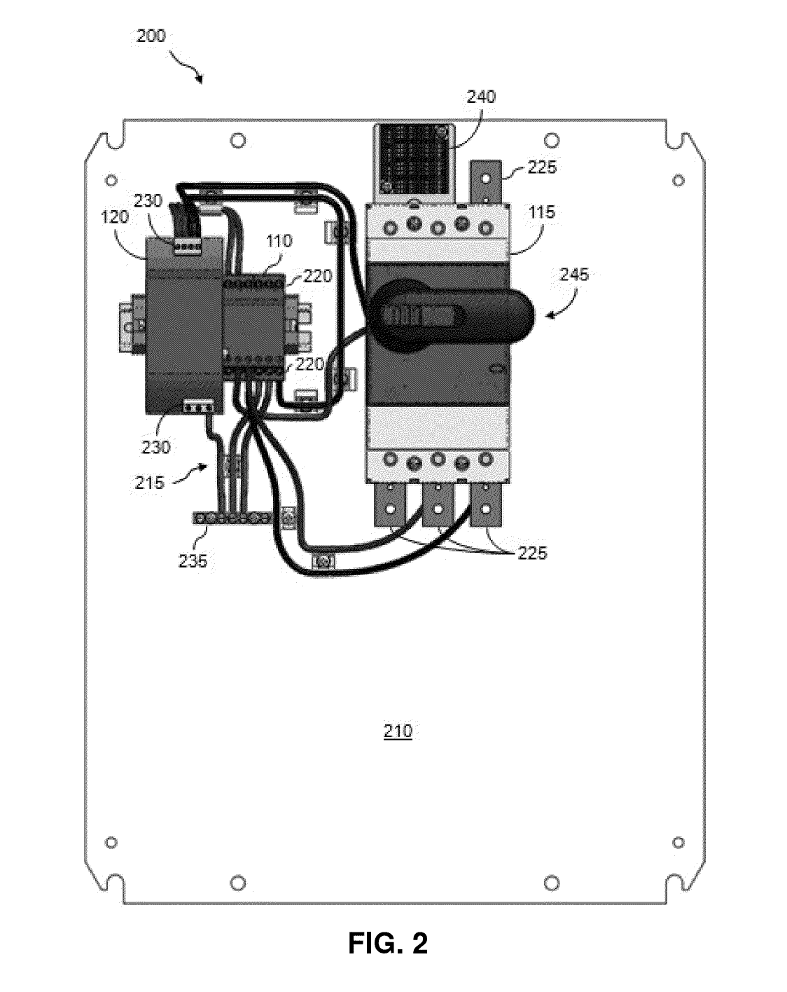

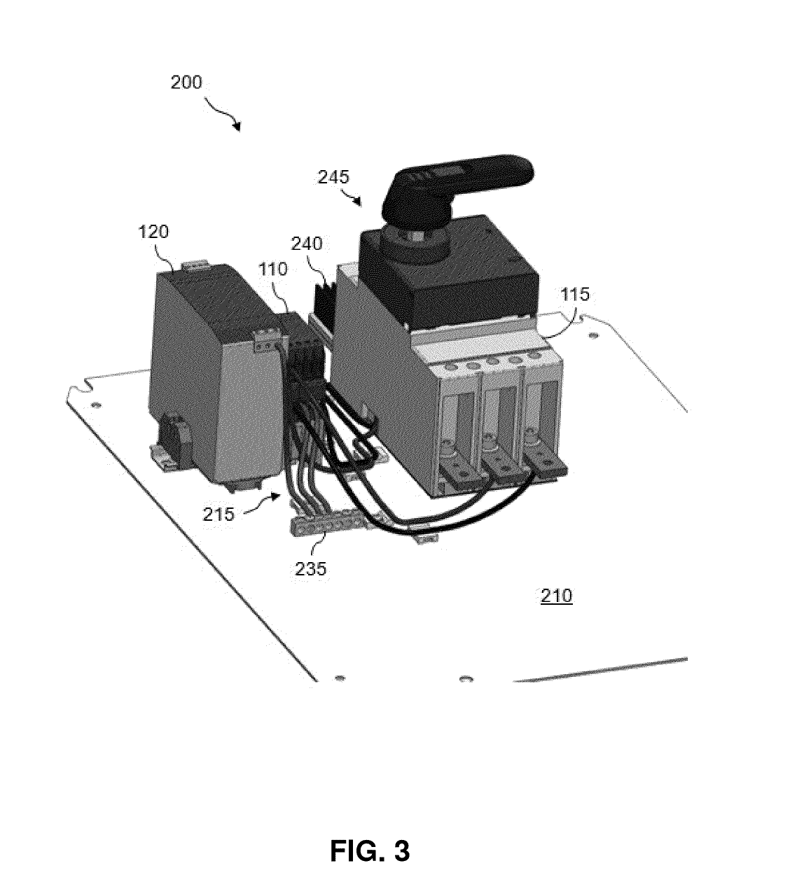

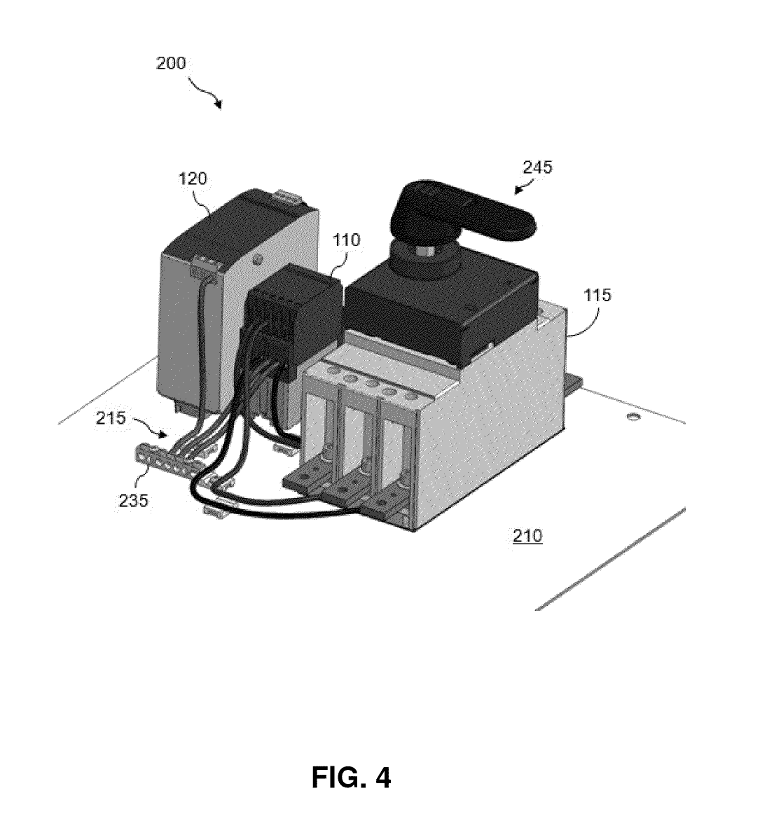

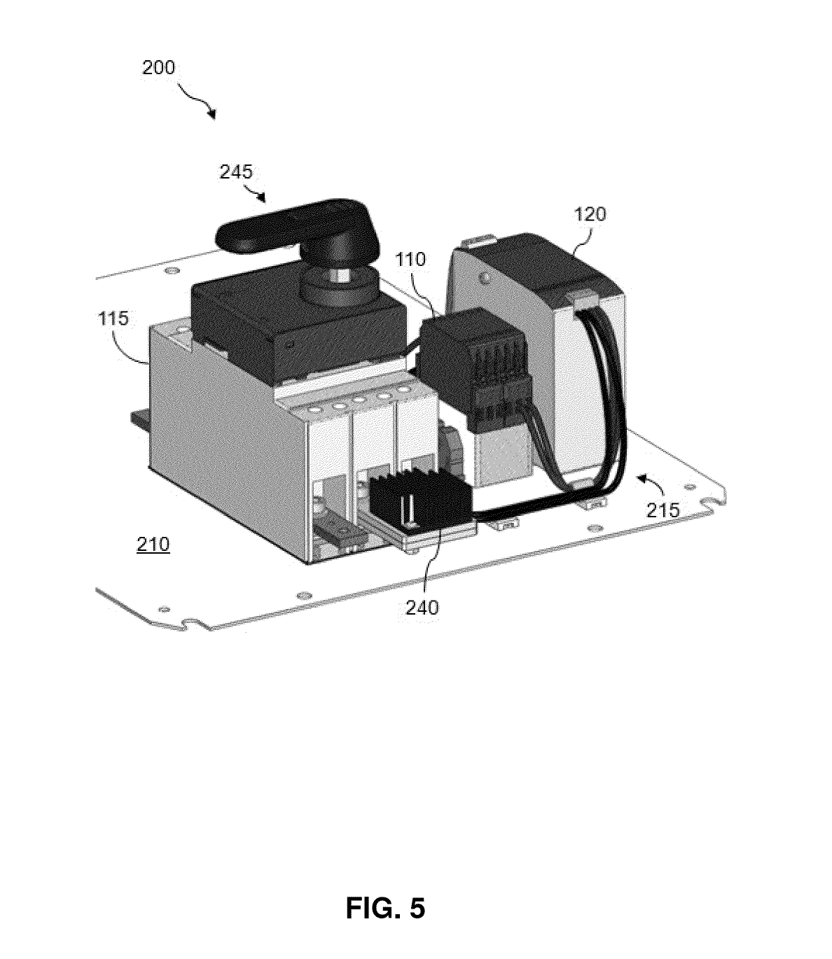

FIG. 2, FIG. 3, FIG. 4, FIG. 5, and FIG. 6 illustrate various views of an example of a monitoring system assembly 200 for implementing the monitoring system 100 of FIG. 1. Namely, FIG. 2 shows a plan view of the monitoring system assembly 200 and FIG. 3, FIG. 4, FIG. 5, and FIG. 6 show various perspective views of the monitoring system assembly 200. FIG. 2, FIG. 3, FIG. 4, FIG. 5, and FIG. 6 show the IR monitoring device 110, the disconnect switch 115, and the power supply 120 installed on a mounting plate 210. The IR monitoring device 110, the disconnect switch 115, and the power supply 120 are electrically connected via an arrangement of wires 215. The arrangement of wires 215 includes, for example, one or more green “ground” wires, one or more white or red “supply” wires, and one or more black “return” wires. The IR monitoring device 110 includes terminals 220, the disconnect switch 115 includes terminals 225, and the power supply 120 includes terminals 230 for connecting to the ends of the wires 215. Certain wires 215 can also be connected to a terminal or bus bar 235 that is installed on the mounting plate 210.

In one example, there are two wires 215 that connect from the IR monitoring device 110 to disconnect switch 115. In a PV field, those same terminals are also connected to the PV wires in the solar energy system. This is the node at which the pulse signal is injected into the solar energy system for determining the probability of insulation breakdown.

FIG. 2, FIG. 3, FIG. 4, FIG. 5, and FIG. 6 show that the disconnect switch 115 also comprises a heat sink 240 and a handle assembly 245. The heat sink 240 is provided for dissipating heat from the disconnect switch 115. The handle assembly 245 comprises a housing for mounting atop the body of the disconnect switch 115 and a grip for manually and rotatably turning the disconnect switch 115 off and on.

Additionally, the IR monitoring device 110 can be used to turn off the monitoring system 100, except without requiring operator involvement. Although not shown, this monitoring system assembly 200 also comprises an electrical input hub onto a bus bar, and an output which leads to an inverter. The presently disclosed monitoring system assembly 200 is desirably integrated with a combiner box (not shown), and most desirably integrated with a combiner box having wireless monitoring capability, such as that which is disclosed in U.S. patent application Ser. No. 12/871,234, filed Aug. 20, 2010, and issued as ______, which is hereby incorporated by reference in its entirety.

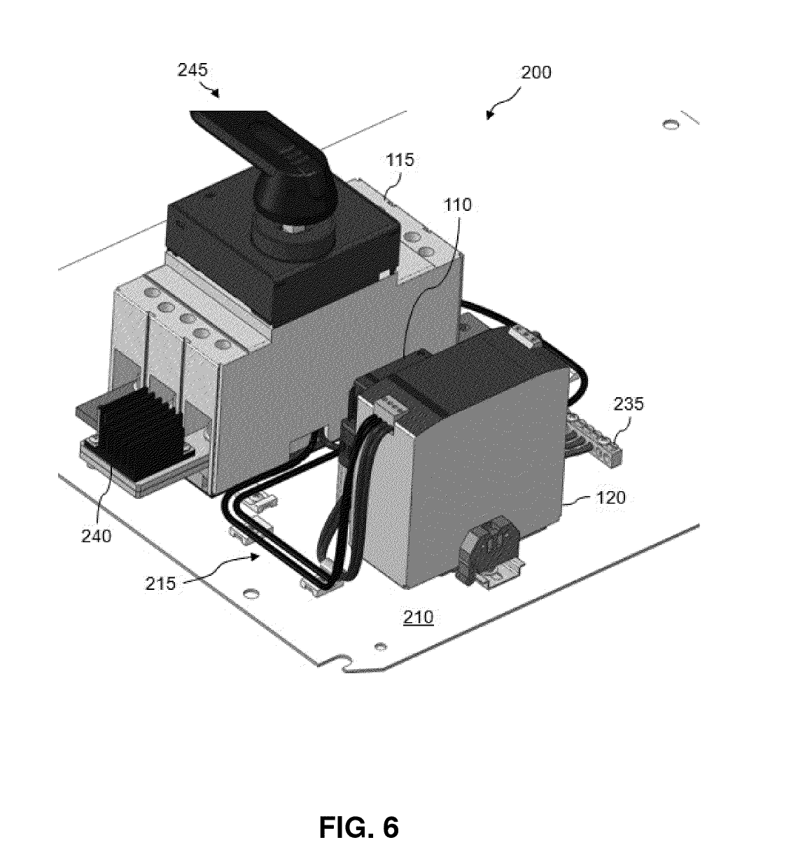

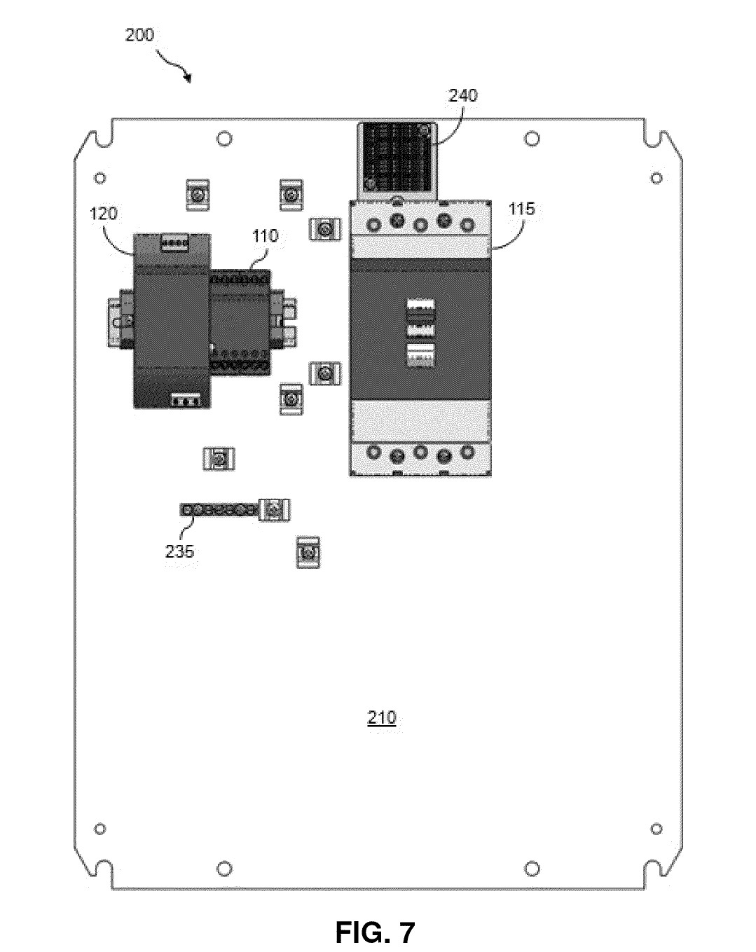

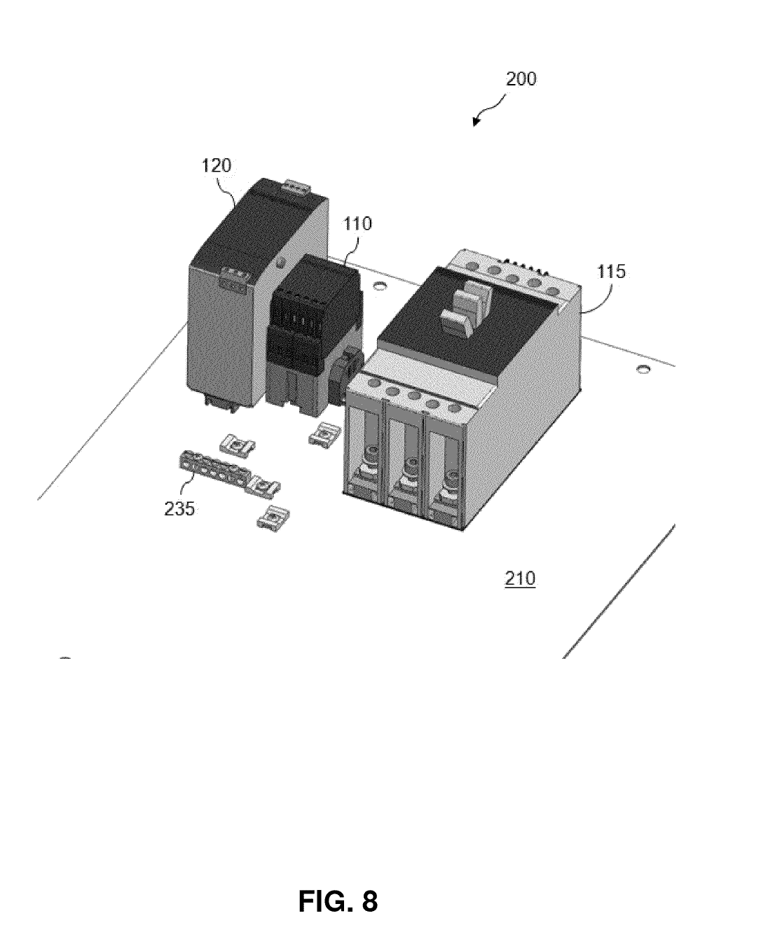

FIG. 7, FIG. 8, and FIG. 9 illustrate yet other views of the monitoring system assembly 200, albeit without the handle assembly 245 and the wires 215.

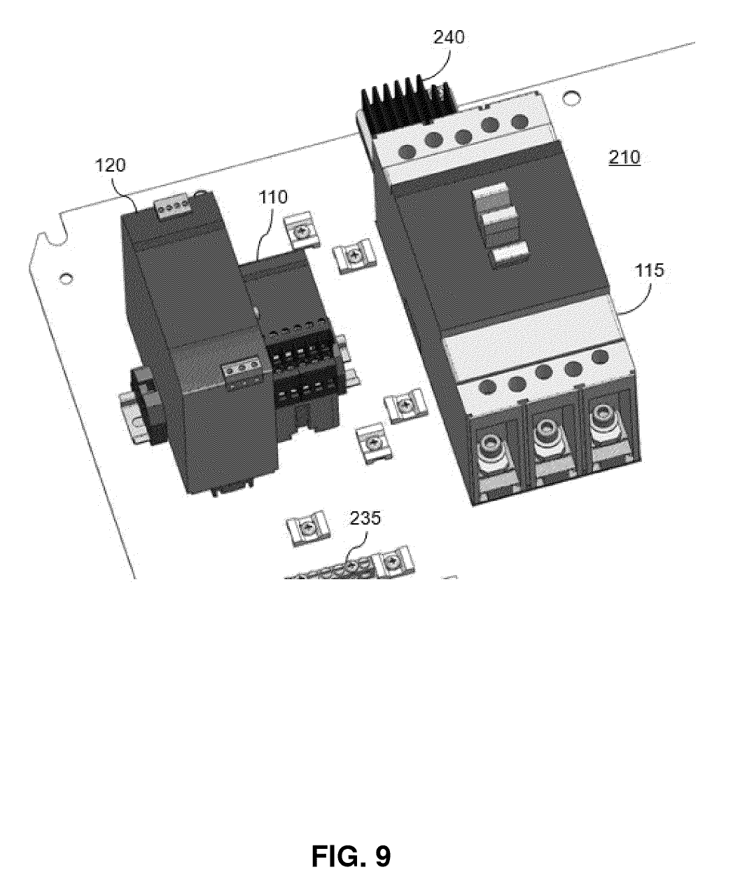

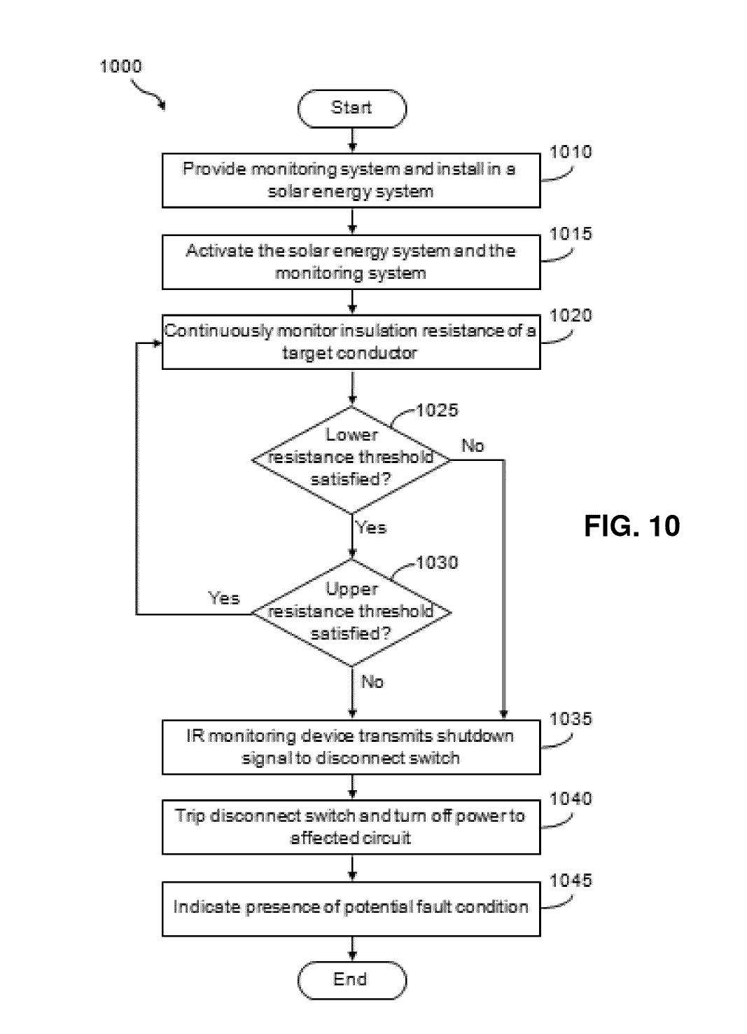

FIG. 10 illustrates a flow diagram of an example of a method 1000 of preventing electrical arcs in a solar energy system using the monitoring system 100 of FIG. 1. The method 1000 may include, but is not limited to, the following steps.

At a step 1010, the monitoring system 100 is provided and installed in a solar energy system. For example, the monitoring system 100 is instantiated as the monitoring system assembly 200. Then, the monitoring system assembly 200 is installed in a solar energy system. For example, the monitoring system assembly 200 is installed in a combiner box of the solar energy system.

At a step 1015, the solar energy system and the monitoring system 100 are activated.

At a step 1020, using the IR monitoring device 110, the insulation resistance of a target conductor is continuously monitored. For example and referring now to FIG. 1, using the IR monitoring device 110, the insulation resistance of the conductor 155 is continuously monitored.

At a decision step 1025, using the IR monitoring device 110, it is determined whether the lower resistance threshold is satisfied. If the lower resistance threshold is satisfied, a signal is generated that the lower resistance threshold is met, then the method 1000 proceeds to the step 1030. However, if the lower resistance threshold is not satisfied, a signal is generated that the lower resistance threshold is not met, then the method 1000 proceeds to a step 1035.

At a decision step 1030, using the IR monitoring device 110, it is determined whether the upper resistance threshold is satisfied. If the upper resistance threshold is satisfied, a signal is generated that the upper resistance threshold is met, then the method 1000 returns to the step 1020. However, if the upper resistance threshold is not satisfied, a signal is generated that the upper resistance threshold is not met, then the method 1000 proceeds to a step 1035.

At the step 1035, the IR monitoring device 110 transmits a shutdown signal to the disconnect switch 115, wherein the shutdown signal indicates that the measured insulation resistance is outside the preset thresholds of the IR monitoring device 110.

At a step 1040, upon receiving the shutdown signal from the IR monitoring device 110, the disconnect switch 115 is tripped and the power to the affected circuit is turned off. For example and referring again to FIG. 1, the disconnect switch 115 is tripped and the power to the PV source or output circuit 160 is turned off.

At a step 1045, the presence of the potential fault condition is indicated. For example and referring again to FIG. 1, the indicator 125, such as an LED, is activated to indicate the presence of the potential fault condition in the conductor 155 associated with the PV source or output circuit 160. Optionally, using the communications interface 130, a message (text, email, or otherwise) about the presence of the potential fault condition and that the power to the PV source or output circuit 160 has been turned off is transmitted to the designated operator of the solar energy system 150.

In the event that the solar energy system or a portion thereof is shutdown according to the method 1000, service personnel can replace or repair the failing conductor and then reactivate the system.

In summary and referring now to FIG. 1 through FIG. 10, the presently disclosed monitoring system 100, which by way example is instantiated via the monitoring system assembly 200, and the method 1000 allow for the early detection of potential arc fault conditions and can be used to shut down the power in a solar energy system prior to an actual arc occurring, thereby reducing or entirely eliminating a potential hazardous condition from occurring.

As used herein, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items. It should also be understood that “approximately” and the like is +/−10% unless otherwise stated or not feasible. Moreover, all ranges include the stated endpoints, as well as all increments therebetween.

Although the foregoing subject matter has been described in some detail by way of illustration and example for purposes of clarity of understanding, it will be understood by those skilled in the art that certain changes and modifications can be practiced within the scope of the appended claims.

We claim:

1. An system for preventing electrical arcs in solar fields including:
a. A power supply;
b. A insulation resistance (IR) monitoring device electrically coupled to said power supply;
c. A disconnect switch electrically coupled to said IR monitoring device; and
d. A solar energy system electrically coupled to said IR monitoring device.

2. The system of claim 1 wherein said solar energy system includes a combiner box.

3. The system of claim 2 wherein said combiner box has wireless monitoring capability.

4. The system of claim 2 wherein said combiner box includes a plurality of conductors.

5. The system of claim 4 wherein said IR monitoring device transmits and measures a pulsating measuring signal.

6. The system of claim 5 wherein said disconnect switch is activated by said IR monitoring device.

7. The system of claim 6 further comprising a communications interface for indicating an event selected from tripping IR monitor, tripping disconnect switch, and combinations thereof.

8. A non-arcing solar energy system including:
a. A plurality of solar panels;
b. A combiner box electrically coupled to said solar panels;
c. An insulation resistance (IR) monitoring device electrically coupled to said combiner box; and
d. A wireless communications interface.

9. The non-arcing solar energy system of claim 8 further comprising a disconnect switch electrically coupled to said IR monitoring device.

10. The non-arcing solar energy system of claim 9 wherein said disconnect switch further includes a heat sink.

11. The non-arcing solar energy system of claim 9 wherein said disconnect switch includes a handle for manual on and off switching.

12. The non-arcing solar energy system of claim 8 wherein said combiner box has wireless monitoring capability hardware.

13. The non-arcing solar energy system of claim 12 wherein said wireless communications interface is coupled to said wireless monitoring capability hardware.

14. A method of preventing electrical arcs in a solar energy system including the steps of:
a. Connecting an IR monitoring device to a combiner box;
b. Measuring the insulation resistance of a conductor in said combiner box;
c. Transmitting a shutdown signal to a disconnect switch in response to a resistance measurement that falls outside a predetermined range; and
d. Decreasing power to the system in response to said shutdown signal.

15. The method of claim 14 further including the step of communicating a message when said resistance measurement falls outside said predetermined range.

16. The method of claim 15 wherein said method of communication is selected from the group consisting of sending a text message, sending an email, and combinations thereof.

17. The method of claim 14 further including the step of repairing or replacing a conductor whose insulation resistance fell outside said predetermined range.
